(19) United States
(12) Patent Application Publication
(10) Pub. No.: US 2021/0156799 A1
(43) Pub. Date: May 27, 2021

(54) OPTICAL SMOKE DETECTOR WITH SCATTERED RADIATION

(71) Applicant: WeMaintain, Neuilly-sur-Seine (FR)

(72) Inventor: Olivier COMETS, Paris (FR)

(21) Appl. No.: 17/048,377

(22) PCT Filed: Mar. 6, 2019
(86) PCT No.: PCT/FR2019/050500

§ 371 Date: Oct. 16, 2020

(30) Foreign Application Priority Data
Apr. 19, 2018 (FR) 18 53469

(51) Int. Cl. G01N 21/53

(52) U.S. Cl. CPC G01N 21/53

(57) ABSTRACT

“An optical smoke detector with scattered radiation includes a housing enclosing a measurement volume that is accessible to the smoke particles in a measurement chamber comprising a upper part (51), the measurement volume being defined by a volume of intersection between a cone of emission of at least one first emitter (7) of radiation at a first predefined emission wavelength, and a cone of reception of a receiver of radiation capable of receiving radiations scattered on smoke particles. Any portion of internal surface of the upper part (51) of the measurement chamber directly forming an obstacle to the radiation emitted in the cone of emission has a roughness capable of generating a scattered reflection of this radiation.”

The present invention relates to an optical smoke detector operating according to the scattered radiation principle. It applies in particular to the detection of smoke in any building, public or private, residential, industrial or commercial.

Many smoke detectors intended to be placed at strategic points in buildings have already been proposed, so as to alert the occupants as early as possible to combustion or fire starting.

Among the smoke detectors that have been proposed, the optical smoke detector with scattered radiation, using the Tyndall effect (phenomenon of scattering of an incident light on particles of material), is in particular known. In such an optical detector, the detection of the smoke particles is performed by measurement of a radiation scattered on these smoke particles. More specifically, a measurement chamber internal to the optical smoke detector with scattered radiation comprises a measurement volume that is accessible to the smoke particles, a volume to which the radiation from a radiation emitter (for example a light-emitting diode) is directed. A light receiver (for example a photodiode, a photoconductor or a photocapacitor), sensitive to the radiation emitted by the radiation emitter, is also arranged in the detector to receive the radiation scattered by smoke particles present in the measurement chamber. When there is no smoke in the measurement chamber, the optical detector is configured so that the light receiver receives only a minimal quantity of radiation, if possible nil. Conversely, when smoke penetrates into the measurement chamber, the smoke particles will scatter the radiation originating from the radiation emitter, and thus illuminate the radiation receiver. A signal received on the radiation receiver, of which the amplitude remains greater than a predefined sensitivity threshold for a predefined minimum duration, provokes the switching of the detector to an alarm state, then the reporting of this state to a central facility and/or the generation of an audible and/or visual alarm on the detector to warn of combustion or fire starting.

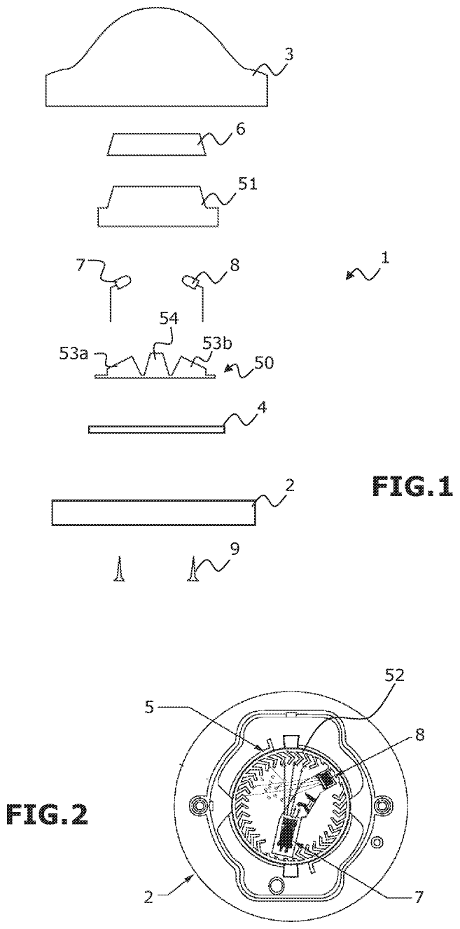

FIG. 1 schematically illustrates, in exploded perspective, the constituent elements of a standard optical smoke detector with scattered radiation, and FIG. 2 illustrates a cross section of a known example of arrangement of optical elements in a standard measurement chamber.

Such an optical detector 1 conventionally comprises a housing formed by the assembly of a plate 2, and of a cap 3, defining the physical enclosure of the detector. This optical detector 1 is generally attached, by the bottom face of the plate, to another part fixed to the ceiling, called ceiling mount and not represented. The cap 3 then constitutes the visible part of the detector 1 when the latter is in place. Inside the housing, a printed circuit board 4 is received in the plate 2, and topped by a measurement chamber 5 (see FIG. 2) conventionally consisting of two parts: a first part, called lower or bottom part 50, placed directly on the printed circuit board 4, and a second part, called upper or top part 51, cooperating with the lower part 50 to delimit an internal space that is accessible to the smoke particles through apertures 52 formed in the lateral wall of the upper part 51 (see FIG. 2). It should be noted that the concept of lower or bottom part, on the one hand, and of upper or top part on the other hand, should be understood in relation to the orientation of the device 1 as represented in FIG. 1. Obviously, when the device 1 is fixed to a ceiling, the upper and lower parts are reversed with respect to the vertical of a terrestrial reference frame. A filtering device 6, for example a metal grating or a cylindrical nylon net with fine mesh, is advantageously fitted around the lateral wall of the upper part 51 opposite the apertures 52, notably to prevent insects from penetrating into the measurement chamber 5. An emitter 7 of radiation and a receiver 8 of radiation sensitive to the radiation emitted by the emitter 7, are mounted on the printed circuit board 4, in the example, through the lower part 50. The various components above are assembled via assembly screws 9. In some cases, these elements are held together by clips.

Inside the measurement chamber 5, the measurement volume of the smoke detector corresponds to the volume of intersection between the radiation beam (or cone of emission) of the emitter 7 and the solid angle of reception (or cone of reception) of the radiation receiver 8. The positioning of the emitter 7 and of the receiver 8 should consequently be very precise so as to optimize this measurement volume. In order to avoid any direct radiation from the emitter 7 to the receiver 8, the emitter 7 and the receiver 8 are traditionally mounted so as to form an angle, generally between 120 and 130 degrees, as can be seen in FIG. 2. In the embodiment of FIGS. 1 and 2, the emitter 7 and the receiver 8 are through-hole mount components mounted on the printed circuit board 4 through the lower part 50, such that their active part is placed inside the measurement chamber 5. The emitter 7 and the receiver 8 are also positioned with a certain angle with respect to the printed circuit board 4. This angle is approximately 35 degrees in some embodiments. To guarantee this positioning, guiding forms 53a, 53b forming a support for the active parts of the emitter 7 and of the receiver 8 are generally provided on the top surface of the bottom part 50. Physical barriers, such as the low wall 54, are also conventionally provided on the top surface of the bottom part 50 to eliminate any direct radiation.

For the smoke detectors such as that represented in FIGS. 1 and 2, the lower part 50 and the upper part 51 of the measurement chamber are generally made of two injection-moulded parts, preferably made of plastic. The parts are also of black colour so as to guarantee the best absorption of the radiation emitted by the emitter 7 in the absence of smoke particles, whatever the radiation wavelength used. The cap 3 is, for its part, a part also produced by plastic injection moulding. The colour used for the cap 3 can nevertheless be any colour, generally white so as to be matched to ceilings.

The construction of the above optical detectors thus requires the production and relatively complex manual assembly of numerous parts. It is notably necessary to pass the electrical connection leads of the emitter and of the receiver through the lower part 51 to solder then onto the circuit board 4, then to ensure that the active parts are correctly positioned on the guiding forms 53a, 53b. The result thereof is a costly product.

Enhancements to the optical smoke detector described above have been proposed in order, on the one hand, to make the mounting of the optical components on the printed circuit board easier, and, on the other hand, to guarantee a precise angular positioning of the radiation beam of the emitter and of the solid angle of the receiver. These enhancements, described for example in the documents U.S. Pat. No. 8,441,368 and WO 2012/035259, rely on the use of an emitter and an associated receiver that are directly surface-mounted on a printed circuit board, at a sufficient distance from one another (of the order of 5 centimetres). The cone of emission of the emitter and the cone of reception of the receiver thus extend parallel to one another, and at right angles with respect to the printed circuit board, with no zone of intersection.

The measurement volume inside the measurement chamber is obtained through the use of waveguides placed opposite the active parts of the emitter and of the receiver which are situated under the bottom part of the measurement chamber. The other parts presented in FIG. 1 are unchanged. In particular, the measurement chamber is produced in the form of two parts moulded by plastic injection moulding, still of black colour to guarantee the absorption of the beams radiated in the absence of smoke particles. These enhancements allow for a very precise and automated placement of the components on the board (surface-mounted component or SMC technique), somewhat simplify the mounting and make the performance levels from one detector to another more constant. It is nevertheless still necessary to provide, as in the case of FIG. 1, for the production and the assembly of a board, of a measurement chamber with its upper and lower parts, of optical waveguides to reorient the beam radiated by the emitter and the solid angle of the receiver according to an angle of between 120 and 130 degrees, of a filtering device, of a cap and of a support plate.

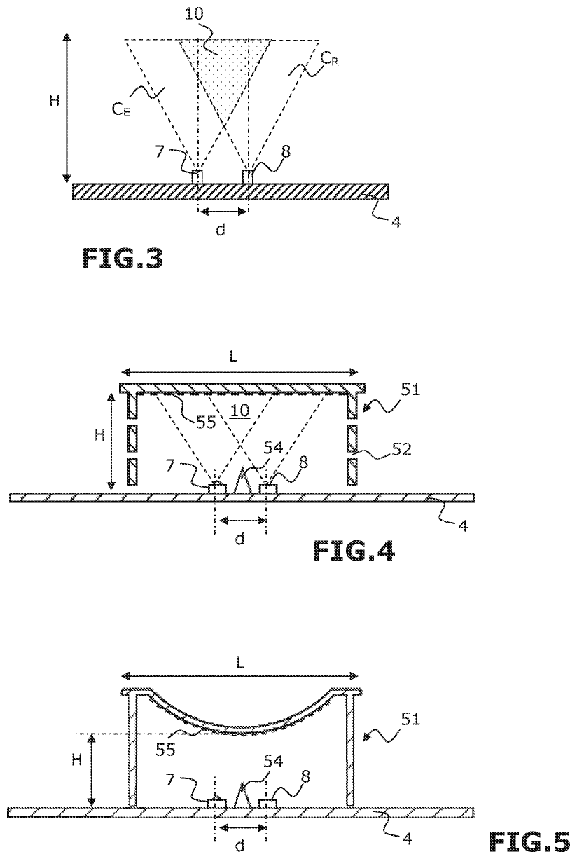

More recently, as represented schematically in FIG. 3, electronic modules have been developed proposing a printed circuit board 4 on which the emitter 7 of radiation and the associated receiver 8 are mounted at a very small distance d from one another (typically between 1.7 and 2 millimetres). An electronic module of this type is for example marketed by Silicon Laboratories under the product reference Si114x, by Analog Devices under the product reference ADPD145BI, or by Maxim Integrated under the product reference MAX30105. By bringing the optical components drastically closer together, it is possible to dispense with the need for the optical guides since there is naturally a zone 10 of intersection between the cone of emission C_{E} and the cone of reception C_{R}, this zone 10 of intersection forming the measurement volume of the detector. These modules have been developed and designed to operate directly in the open air, the measurement volume then being a measurement volume external to the smoke detector and making it possible to dispense with the internal measurement chamber as explained for example in the document U.S. Pat. No. 9,142,112.

These electronic modules could be used also with conventional measurement chambers internal to the optical smoke detector, similar to that described in FIG. 1, that is to say formed by a lower part 50 and an upper part 51 of black colour to guarantee the absorption of the radiation emitted in the absence of smoke particles inside the chamber and thus prevent the receiver from being blinded.

The present invention falls within the recent approaches to enhancements of optical smoke detectors with scattered radiation incorporating an internal measurement chamber, notably in order to reduce the number of parts to be assembled compared to the configuration of FIG. 1, and/or reduce the bulk.

More specifically, the subject of the present invention is an optical smoke detector with scattered radiation comprising a housing enclosing a measurement volume that is accessible to the smoke particles in a measurement chamber comprising an upper part, said measurement volume being defined by a volume of intersection between a cone of emission of at least one first emitter of radiation at a first predefined emission wavelength, and a cone of reception of a receiver of radiation capable of receiving radiations scattered on smoke particles, characterized in that said at least one first emitter of radiation and the receiver of radiation are mounted in the measurement chamber, on the surface of a printed circuit board placed under the upper part and in that any portion of internal surface of the upper part of the measurement chamber directly forming an obstacle to the radiation emitted in the cone of emission has a roughness capable of generating a scattered reflection of this radiation.

By virtue of these provisions, it is possible to produce the part forming the upper part of the measurement chamber in any colour, contrary to the detectors of the prior art described above for which the measurement chamber can only be of black colour.

In a preferred embodiment, the housing of the detector is formed by the assembly of a plate and a cap, and the upper part of the measurement chamber is injection moulded in a single part of any colour with the cap.

In one possible embodiment, the roughness is defined by an arithmetic mean roughness Ra greater than or equal to a quarter of the first emission wavelength, advantageously less than or equal to fifty times the first emission wavelength, and preferably of between half and ten times the first emission wavelength.

According to one possible embodiment, the measurement volume also comprises a volume of intersection between a cone of emission of a radiation at a second emission wavelength distinct from the first emission wavelength, and a cone of reception of the radiation scattered on smoke particles at this second wavelength. This particular feature advantageously allows the detector to be able to discriminate the types of smoke particles.

The first emission wavelength is for example substantially equal to 450 nanometres, corresponding to an emission of blue colour, and the second emission wavelength is for example substantially equal to 950 nanometres, corresponding to an infrared emission. “Substantially” with respect to the wavelengths is understood to mean between 450 and 500 nanometres for a blue colour emission, and between 800 and 1050 nanometres for an infrared emission.

In this case, the roughness of any portion of internal surface of the upper part of measurement chamber directly forming an obstacle to the radiation emitted at the first wavelength and/or at the second wavelength is defined by an arithmetic mean roughness Ra preferably substantially equal to 0.8.

In one possible embodiment according to the invention, the first emitter of radiation and the receiver of radiation are advantageously mounted on the surface of a printed circuit board placed under the measurement chamber so that the cone of emission and the cone of reception extend in two substantially parallel directions of orientation, the two directions of orientation being substantially orthogonal to the printed circuit board. “Substantially orthogonal” is understood to mean that the two directions each form an angle of 90° with the plane of the printed circuit board, with a tolerance of plus or minus 5°.

The first emitter of radiation and the receiver of radiation are then preferably positioned on the printed circuit board such that said two substantially parallel directions of orientation are separated by a distance d less than 2.5 millimetres.

According to a particularly advantageous embodiment of the invention in terms of bulk, the upper part of the measurement chamber has a top internal surface separated from the printed circuit board by a minimum distance H substantially equal to ten times the distance d.

The invention will be better understood in light of the followed detailed description, given with reference to the attached figures, in which:

FIG. 1, already described above, schematically illustrates, in an exploded view, an example of optical smoke detector with scattered radiation according to the prior art;

FIG. 2, already described above, is a cross section of an example of known arrangement of optical elements in a standard measurement chamber;

FIG. 3, already described above, schematically illustrates another known example of arrangement of optical elements for a smoke detector without internal measurement chamber;

FIG. 4 schematically represents a cross section of a measurement chamber arranged on a printed circuit board for an optical smoke detector according to a possible embodiment according to the invention;

FIG. 5 schematically represents a cross section of a measurement chamber arranged on a printed circuit board for an optical smoke detector according to a possible variant embodiment according to the invention;

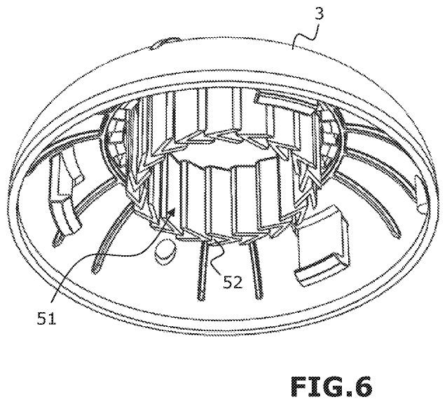

FIG. 6 is a perspective of a single part forming a measurement chamber and external cap for an optical smoke detector according to a possible embodiment of the invention.

Hereinafter, and unless provided otherwise, the elements that are common to the different figures bear the same references.

Referring to FIGS. 4 and 5 which represent preferred but nonlimiting embodiments of the invention, the smoke detector with scattered radiation comprises a housing (not represented) enclosing a measurement volume 10 that is accessible to the smoke particles in a measurement chamber comprising an upper part 51. It is recalled that the concept of upper part should be understood in relation to the orientation of the device as represented in FIGS. 4 and 5. Thus, once the detector is fixed to a ceiling, the upper part is at the bottom. As explained above, the measurement volume is defined by a volume of intersection between a cone of emission of an emitter 7 operating at a first predefined emission wavelength, and a cone of reception of a receiver 8 of radiation capable of receiving radiations scattered on smoke particles. The smoke particles can penetrate into the measurement chamber through apertures 52 formed in the lateral wall of the upper part 51.

In the nonlimiting case of FIGS. 4 and 5, the emitter 7 and the receiver 8 are mounted on the surface of a printed circuit board 4 placed under the upper part 51 of the measurement chamber so that the cone of emission and the cone of reception each extend according to an axis or direction of orientation that is substantially orthogonal to the printed circuit board 4. This particular arrangement of the emitter and of the receiver allows for their very accurate and automated placement on a board 4, before any process of assembly of the different parts forming the detector.

The emitter 7 and the receiver 8 of radiation are preferably mounted on the printed circuit board 4 such that a distance d less than 2.5 millimetres, preferably substantially equal to 1.7 or 2 millimetres, separates the axes of the cones of emission and of reception. It is preferable for this distance d to be of the same order of magnitude as the distance separating the vertex of the cone of reception from the smoke particles present in the measurement volume. The cones of emission and of reception thus have a natural volume of intersection, without it being necessary to provide particular waveguides to redirect the rays.

According to the invention, any portion of internal surface of the upper part 51 of the measurement chamber which directly forms an obstacle to the radiation emitted by the emitter 7 in the cone of emission has a roughness generating a scattered reflection of this direct radiation. In the examples represented in FIGS. 4 and 5, given the width L and height H dimensions represented, the portions of internal surface in question are situated particularly on the top internal surface 55 of the upper part 51. Here, as represented in FIGS. 4 and 5 by thick broken lines, all the top internal surface 55 is designed to have a sufficient roughness to scatter the radiation received from the emitter 7 (although in theory, only the portion of this top internal surface 55 directly opposite the cone of emission needs to have this roughness). In other embodiments that are not represented, for which it would be desirable to reduce the width L of the upper part 51 of the measurement chamber, other zones of internal surface, in particular on the lateral wall of the upper part 51, could also directly form an obstacle to the radiation emitted by the emitter 7, in which case these portions will have to be also designed to have a surface of sufficient granularity or roughness to scatter the radiation received from the emitter 7. Different forms can be given to the top internal surface 55 of the measurement chamber, such as a planar surface as in the case of FIG. 4, or else a concave surface as in the case of FIG. 5.

By virtue of this particular feature linked to the surface roughness, it now becomes possible to produce the part forming the upper part 51 of the measurement chamber in any colour, contrary to the detectors of the prior art described above for which the measurement chamber can only be of black colour. Indeed, if an attempt is made to use colours other than black for a measurement chamber of known type placed opposite the optical arrangement represented in FIG. 3, it would be necessary to provide a minimum height H for the upper part of the measurement chamber so as not to blind the receiver in normal conditions (that is to say in the absence of smoke particles). Tests have shown that, for most colours other than black, the height H of the measurement chamber of black absorbent colour should be at least of the order of 20 times greater than the distance d separating the emitter 7 from the receiver 8. This minimum height can even be of the order of 10 centimetres if it is sought to use a chamber of smooth white colour, which is obviously incompatible with the bulk constraints.

Alternatively, by conferring, in accordance with the invention, at least on the portions of internal surface of the upper part 51 that are directly illuminated by the emitter 7, a sufficient roughness, it is possible to obtain a situation in which the direct radiation from the emitter that is scattered by these portions does not blind the receiver in normal conditions, regardless of the colour used in the production of the measurement chamber (including white). Indeed, the incident radiation from the emitter 7 will be reflected on this surface in a plurality of directions, the incident wave undergoing a multitude of reflections in different directions and going back as a multitude of small independent waves. Tests have made it possible to demonstrate that even by using a white colour which is the least favourable, it is possible to lower the minimum height H of the measurement chamber to approximately ten times the distance d (i.e. approximately 2 centimetres in the geometry of the tests).

The roughness of a geometric surface can be defined according to the conventional roughness criteria, for example those used by the standard ISO 4287, relying on height differences of a surface profile that are measured with respect to a reference that is assumed perfect such as a planar surface. In the present case, tests conducted with different colours have made it possible to demonstrate that satisfactory results were obtained by defining the roughness to be used by an arithmetic mean roughness Ra greater than or equal to a quarter of the emission wavelength of the emitter 7. The roughness to be used at least on the portions of internal surface of the measurement chamber that are directly illuminated by the emitter 8 will advantageously be situated within a range between a quarter of the emission wavelength and fifty times this emission wavelength. The roughness to be used at least on the portions of internal surface of the measurement chamber that are directly illuminated by the emitter 8 will preferably be situated within a range between half the emission wavelength and ten times this emission wavelength.

As an example, if the wavelength used is substantially equal to 450 nanometres (blue light), the arithmetic mean roughness Ra will be chosen preferably between 0.22 micrometres and 4.5 micrometres. For a wavelength substantially equal to 950 nanometres (infrared), the arithmetic mean roughness Ra will preferably be chosen between 0.47 micrometres and 9.5 micrometres.

Such a surface roughness can be obtained by any known electrolytic method of machining, spark machining, shot blasting or sandblasting of the surface of the mould then used to injection mould a part, for example made of plastic material. It is also possible to use a matt coating paint at least on the portions of surface in question, paint of which the “gloss” or specular gloss is low, typically less than or equal to 10%, so as to produce a specular reflection lower than the scattered reflection. It is also possible to add an additive into the plastic used for the injection moulding, of mineral, glass fibre or plant fibre type. Finally, this roughness can be obtained by abrasion of the portions of surface of the part in question after its production or its injection moulding, for example using glass paper with a 180 grain, or by sandblasting with glass beads.

In addition to the fact of making it possible to dispense with the colour problem, the surface roughness sought allows the detector to be almost, if not wholly, insensitive to the particles of dust which could be deposited notably on the internal surface of the measurement chamber. Indeed, the grains of dust are generally of a size of the order of one to one hundred times the wavelength but have a coating with a roughness similar to that of the internal surface of the measurement chamber, and thus the level of scattering of the internal surface is virtually unchanged.

Moreover, it is no longer necessary to provide complicated physical barriers, apart from the low wall 54 which remains necessary. The latter can nevertheless be borne directly on the printed circuit board 4 in the form of a component for example, such that, in this case, the lower part 50 of the measurement chamber described with reference to FIG. 1 of the known detectors is spared.

One direct consequence of the fact of having dispensed with the problem of the choice of colour for the upper part 51 of the measurement chamber is that it is now possible to produce, if so desired, this upper part 51 in the same colour as the cap 3 which constitutes the visible part of the detector, for example in white to be matched to the colour of a ceiling to which the detector will be fixed. The upper part 51 of the measurement chamber can therefore now be moulded with the cap 3 in a single piece of any colour. FIG. 6 represents an embodiment of such a part obtained by a single moulding operation.

The invention therefore makes it possible, in some of these variants, to considerably reduce the number of parts to be assembled compared to the detector represented schematically in FIG. 1. It should be noted at this stage that even the filtering device 6 shown in FIG. 1 can be obtained by a method of overmoulding with the single part of FIG. 6. In one possible embodiment, the printed circuit board 4 can even serve as plate for the housing of the detector.

In the above, the use of a single emission wavelength has been described. Obviously, the principle of the invention applies equally to the embodiments in which two distinct emission wavelengths would be used so as to be able to discriminate the type of smoke particles, as is described in the document U.S. Pat. No. 8,907,802. It is thus possible to provide for the measurement volume to also include a volume of intersection between a cone of emission of a radiation at a second emission wavelength distinct from the first emission wavelength, and a cone of reception of the radiation scattered at this second wavelength. This volume of intersection will be able to be the same as the volume of intersection defined for the first wavelength (case where one and the same emitter and one and the same receiver can operate according to both wavelengths) or else slightly offset (case where two emitters and/or two receivers are used). In these different cases, the roughness of the portions of internal surface of the upper part will have to be designed to allow the scattered reflection sought at the two wavelengths. For example if the first wavelength is substantially equal to 450 nanometres (blue light) and the second wavelength is substantially equal to 950 nanometres (infrared), the roughness will be able to be defined by an arithmetic mean roughness Rₐ substantially equal to 0.8 micrometres,

Also, although the invention has been described in context of optical components surface-mounted on a printed circuit board according to cones of emission and of reception each at right angles to the plane of the board, the use of portions of surface with sufficient roughness in accordance with the invention is not incompatible with other arrangements in which the emitter and/or the receiver would be mounted with an angle other than 90° with respect to the printed circuit board.

1. Optical smoke detector with scattered radiation comprising:
a housing enclosing a measurement volume that is accessible to the smoke particles in a measurement chamber having a upper part, said measurement volume being defined by a volume of intersection between a cone of emission of at least one first emitter of radiation at a first predefined emission wavelength, and a cone of reception of a receiver of radiation capable of receiving radiations scattered on smoke particles,
wherein said at least one first emitter of radiation and the receiver of radiation are mounted in the measurement chamber, on the surface of a printed circuit board placed under the upper part and in that any portion of internal surface of the upper part of the measurement chamber directly forming an obstacle to the radiation emitted in the cone of emission has a roughness capable of generating a scattered reflection of this radiation.

2. Optical smoke detector with scattered radiation according to claim 1, wherein said housing is formed by the assembly of a plate and a cap, and in that said upper part of the measurement chamber is injection moulded in a single piece of any colour with said cap.

3. Optical smoke detector with scattered radiation according to claim 1, wherein said roughness is defined by an arithmetic mean roughness Rₐ greater than or equal to a quarter of said first emission wavelength.

4. Optical smoke detector with scattered radiation according to claim 3, wherein said roughness is defined by an arithmetic mean roughness Rₐ less than or equal to fifty times the first emission wavelength.

5. Optical smoke detector with scattered radiation according to claim 3, wherein said roughness is defined by an arithmetic mean roughness Rₐ of between half and ten times the first emission wavelength.

6. Optical smoke detector with scattered radiation according to claim 1, wherein the first emission wavelength is substantially equal to 450 nanometres.

7. Optical smoke detector with scattered radiation according to claim 1, wherein the measurement volume also comprises a volume of intersection between a cone of emission of a radiation at a second emission wavelength distinct from the first emission wavelength, and a cone of reception of the radiation scattered on smoke particles at this second wavelength.

8. Optical smoke detector with scattered radiation according to claim 7, wherein the second emission wavelength is substantially equal to 950 nanometres.

9. Optical smoke detector with scattered radiation according to claims 8,
wherein the first emission wavelength is substantially equal to 450 nanometre, and
wherein the roughness of any portion of internal surface of the upper part of the measurement chamber directly forming an obstacle to the radiation emitted at the first wavelength and/or at the second wavelength is defined by an arithmetic mean roughness Rₐ substantially equal to 0.8 micrometres.

10. Optical smoke detector with scattered radiation according to claim 1, wherein said at least one first emitter of radiation and the receiver of radiation are mounted on the surface of said printed circuit board so that the cone of emission and the cone of reception extend in two substantially parallel directions of orientation, the two directions of orientation being substantially orthogonal to the printed circuit board.

11. Optical smoke detector with scattered radiation according to claim 10, wherein the first emitter of radiation and the receiver of radiation are positioned on said printed circuit board such that said two substantially parallel directions of orientation are separated by a distance d less than 2.5 millimetres.

12. Optical smoke detector with scattered radiation according to claim 10, wherein the upper part of the measurement chamber has a top internal surface separated from the printed circuit board by a minimum distance H substantially equal to ten times the distance d.

13. Optical smoke detector with scattered radiation according to claims 2,
wherein said at least one first emitter of radiation and the receiver of radiation are mounted on the surface of said printed circuit board so that the cone of emission and the cone of reception extend in two substantially parallel directions of orientation, the two directions of orientation being substantially orthogonal to the printed circuit board, and
wherein the printed circuit board forms said plate.
